(19) United States
(12) Patent Application Publication
(10) Pub. No.: US 2017/0240257 A1
(43) Pub. Date: Aug. 24, 2017

(54) SUBMARINE VEHICLE, METHOD FOR PICKING UP A LOAD FROM THE SEABED AND A METHOD FOR SETTING DOWN A LOAD ON THE SEABED

(71) Applicants: ThyssenKrupp Marine Systems GmbH, Kiel (DE); ThyssenKrupp AG, Essen (DE)

(72) Inventors: Hendrik Brandt, Schönkirchen (DE); Axel Panoch, Bordesholm (DE)

(73) Assignees: ThyssenKrupp Marine Systems GmbH, Kiel (DE); ThyssenKrupp AG, Essen (DE)

(21) Appl. No.: 15/503,491

(22) PCT Filed: Jul. 3, 2015
(86) PCT No.: PCT/EP2015/065249

§ 371 Date: Feb. 13, 2017

(30) Foreign Application Priority Data
Aug. 14, 2014 (DE) 10 2014 111 649.6

(51) Int. Cl. B63G 8/00; B63B 5/24; B63B 27/16; B63B 25/00; B63B 27/08; B63B 27/00; G05D 1/00; B63G 8/08

(52) U.S. Cl. CPC B63G 8/001; G05D 1/0038; B63B 5/24; B63G 8/08; B63B 25/002; B63B 27/08; B63B 27/02; B63B 27/16; B63G 2008/005; B63G 2008/004; B63B 2207/02

(57) ABSTRACT

A submarine vehicle may include a storage area for storing loads. The submarine vehicle may further include a pressure hull. The submarine vehicle is configured to pick loads up from a seabed and/or set loads down on the seabed. The storage area may be positioned outside the pressure hull and, in some examples, between numerous pressure hulls. Further, the storage area may include a lower hatch disposed on an underside of the pressure hull or an upper hatch disposed on a top side of the pressure hull. Some submarine vehicles may include a load transporting system for picking the load up from the seabed, setting the load down on the seabed, and/or conveying the load within the storage area.

### PRIOR ART

The present invention relates to a submarine vehicle, preferably to an unmanned submarine vehicle, to a method for picking a load up from the seabed and to a method for setting a load down on the seabed.

Autonomously operated submarine vehicles are known from the prior art, which are preferably used for inspection purposes. Typically, these autonomously operated submarine vehicles are highly restricted with regard to their ability to interact with the surroundings and their diving time during the dive.

As a result of these limitations, these prior art submarine vehicles are not suitable for traveling to different target positions and in each case exchanging loads there. In principle, there are a large number of potential applications for submarine vehicles. For example, for seismic measurements, it is necessary to distribute sensors (for example seismic nodes) at different target positions on the seabed over as extensive an area as possible. A further application for submarine vehicles is the regular exchange of containers with fuels at installations for extracting hydrocarbons. For exchanging individual containers or for exchanging small groups of containers, the prior art knows remotely controlled submarine vehicles, as are known for example from the document U.S. 2009/0114140 A1. Their range is highly limited. Furthermore, effective utilization is dependent on the reaction time of a pilot remotely controlling the submarine vehicle and on the communication between the submarine vehicle and pilot, wherein communication is generally hampered by the diving depth reached during the dive. As a result, effective and uncomplicated exchange of loads cannot be realized via remote control.

Alternatively, the prior art knows methods in which the fuels are transported over long distances to extraction and production sites via hose lines, or umbilicals. In this case, the installation costs are particularly high when only small quantities of fuels are required. In summary, the methods known from the prior art are costly and also time-consuming in particular in the case of remote-controlled submarine vehicles.

### SUMMARY OF THE INVENTION

The object of the present invention is to provide a device with which a plurality of loads at different target positions on the seabed can be exchanged in as economical a manner as possible.

The object of the present invention is achieved by a submarine vehicle having a storage area for storing loads, wherein the submarine vehicle comprises a pressure hull, wherein the submarine vehicle is configured to pick the load up from the seabed and/or to set the load down on the seabed, wherein the storage area is arranged outside the pressure hull.

In contrast to the prior art, the submarine vehicle comprises a storage area outside the pressure hull, as a result of which the storage area can be designed in a correspondingly large manner and a large number of loads can be stored together. The pressure hull or floating body itself can thus be configured in a smaller manner. As a result of the increased capacity, i.e. the increased holding volume compared with the prior art, which can be achieved with the storage area arranged outside the pressure hull, the number of loads that are able to be picked up or exchanged in one dive can be increased. Advantageously, repeated and thus time-consuming and costly surfacing can be avoided as a result. In this way, an effective dive can be carried out, in which loads are exchanged over a large area.

In particular, the submarine vehicle is unmanned and comprises a freely flooded storage area or a wet storage space which is equipped for picking the load up from the seabed and/or for setting the load down on the seabed. Furthermore, provision is preferably made for important systems to be protected from the surrounding water by the pressure hull. It is moreover clear to a person skilled in the art that the submarine vehicle can also comprise several pressure hulls. Preferably, the submarine vehicle is already equipped with a large number of loads at the beginning of the dive. As a result, a large number of loads arranged on the seabed can be exchanged. In this case, provision is preferably made for loads to be picked up or exchanged autonomously in each case at different target positions. These loads may for example be equipment for seismic measurements, for example seismic sensors, or containers for fuels which for the extraction of hydrocarbons. Accordingly, seismic nodes or extraction and/or production sites on the seabed, in particular underwater production sites, are examples of target positions which are approached during a dive in order to pick up in each case one load there and preferably exchange it for a new load. In particular, the pressure hull is configured as a floating body.

Advantageous configurations and developments of the invention can be gathered from the dependent claims and from the description with reference to the drawings.

A further embodiment of the present invention provides that the submarine vehicle is operable autonomously and/or by remote control. In particular, the load is picked up by the submarine vehicle independently, i.e. in particular not by remote control, with the result that it is advantageously possible to dispense with remote control of the submarine vehicle and the known disadvantages thereof. However, it may also be advantageous to control the submarine vehicle at least partially via remote control. For example, it is conceivable for a course correction to be made via remote control.

A further embodiment of the present invention provides that the submarine vehicle comprises a load transporting system for picking the load up from the seabed, for setting the load down on the seabed and/or for conveying the load within the storage area. As a result, the exchange of a load arranged on the seabed can advantageously be carried out in an uncomplicated manner.

A further embodiment of the present invention provides that the submarine vehicle comprises a fuel cell system for supplying the submarine vehicle with energy. By way of the fuel cell system, an energy supply can advantageously be made available, with which long diving times are able to be realized. Preferably, individual propellants (starting materials) that are required for operating the fuel cell, for example oxygen and hydrogen, are stored separately from one another in each case in tanks. If the submarine vehicle comprises several pressure hulls, it is additionally conceivable for the propellants (starting materials) that are required for operating the fuel cell system to be carried along in different pressure hulls.

A further embodiment of the present invention provides that, for large diving depths, the pressure hull is manufactured from a fiber reinforced plastic (for example carbon fiber reinforced plastic), titanium and/or from a composite of these materials. In particular, a titanium end plate can be provided for the pressure hull. As a result of the use of fiber reinforced plastic and/or titanium as materials for the pressure hull, the submarine vehicle can be subjected to pressures that are so high as to allow a dive to several thousand meters. As a result, a deep-lying seabed can advantageously also be reached with the submarine vehicle.

A further embodiment of the present invention provides that the storage area comprises a lower hatch arranged on an underside of the submarine vehicle and/or an upper hatch arranged on a top side of the submarine vehicle. In particular, provision is made for the lower hatch to be provided for receiving the loads arranged on the seabed and/or for exchanging them for new loads. The upper hatch is preferably provided for withdrawal from or charging of the storage area when the submarine vehicle is located at the water's surface, on a ship and/or on a platform. Preferably, the upper hatch has larger dimensions than the lower hatch. In particular, the upper hatch is provided for the simultaneous withdrawal of and/or the simultaneous charging with several loads, while the load is in each case receivable or exchangeable individually through the lower hatch. Furthermore, it is conceivable for the upper hatch and/or the lower hatch to be closable and to be accordingly opened for receiving and/or discharging loads and to be closed for example for the time of the dive between two target positions.

A further embodiment of the present invention provides that the load transporting system comprises a lifting device, preferably a crane, for transporting the load in a substantially horizontal direction, wherein the load transporting system comprises a pickup device, preferably a suction bell or a grasper. As a result, the load can advantageously be raised, for example directly from the seabed, and conveyed into the storage area through the lower hatch or conveyed out of the storage area and out of the submarine vehicle through the open lower hatch and set down on the seabed. The lifting device with the pickup device can advantageously also be used for transporting loads within the storage area. As a result, it is advantageously possible to sort loads within the storage area, for example during a dive between two target positions, and to make the exchange of loads at the target position easier and/or quicker as a result of the newly created order. It is furthermore conceivable for the load transporting system to be configured such that, depending on the target position, the load transporting system selects that load from the large number of loads stored in the storage area that is intended for the respective target position.

A further embodiment of the present invention provides that the load transporting system comprises a rail system for transporting the load within the storage area. As a result of the rail system, the picked-up load can advantageously be transported within the storage area, preferably in a direction parallel to the longitudinal axis of the submarine vehicle. In particular, the entire available holding volume of the storage area can be used through the use of the rail system—even when there is a lower hatch with comparatively small dimensions relative to the storage area. In this case, the lifting device is preferably connected to the rail system via a trolley that is movable along the rail system.

A further embodiment of the present invention provides that the submarine vehicle comprises a grasping device, wherein the grasping device comprises a catching arm, preferably a plurality of catching arms, for catching a cable fastened to the load, wherein the submarine vehicle comprises a winch for raising the load, wherein the submarine vehicle comprises a pickup carriage for arranging beneath the raised load, wherein the submarine vehicle comprises a cutting device for cutting the cable. In this case, provision is made in particular for a cable to be fastened to the load to be picked up, wherein the cable extends, on account of its own buoyancy or in a manner brought about by a buoyant element or buoyant body, from the load arranged on the seabed in the direction of the water's surface. A guide on the submarine vehicle guides the cable floating up to the water's surface to the catching arms on the winch of the grasping device, wherein the guide is preferably designed such that when the submarine vehicle moves in the direction of travel, it at least partially guides the cable. Preferably, the submarine vehicle is in motion during capture and the cable is picked up by the catching arms of the winch. As a result of the winch being set into operation, the load can be raised from the seabed, in that the winch winds up the cable. In particular, the load is raised with the winch until the pickup carriage, which is preferably displaceable in a direction extending substantially parallel to the longitudinal axis of the submarine vehicle, is able to be placed under the raised load. Furthermore, provision is made for the pickup carriage to be displaceable reversibly between a first operating position, in which the pickup carriage is arranged at least partially beneath the grasping device, and a second operating position, in which the pickup carriage is arranged at least partially beneath the lower hatch. In particular, the first operating position is taken up as soon as the load has been raised by the winch. Subsequently, the winch unwinds the cable again in continued operation until the load is positioned on the pickup carriage in the first operating position. Subsequently, the pickup carriage is transferred into the second operating position. The load can then advantageously be received in the storage area from the pickup carriage by means of the lifting device in the second operating position. In particular, by way of the grasping device, the load can be picked up during a dive, i.e. with a submarine vehicle in motion. As a result, it is advantageously possible to dispense with time-consuming maneuvering, by way of which the submarine vehicle would otherwise have to be oriented until the lower hatch is arranged above the load arranged on the seabed.

A further embodiment of the present invention provides that the submarine vehicle comprises a plurality of pressure hulls, wherein the storage area is arranged between the pressure hull and a further pressure hull. Preferably, the storage area is arranged between the pressure hull and the further pressure hulls such that the storage area is protected from environmental influences by the pressure hull at least partially on the starboard and/or port side. In particular, provision is made for the height of the pressure hulls to define substantially the height of the submarine vehicle and for the pressure hulls to each be connected rigidly to the storage area via at least one connecting element.

A further embodiment of the present invention provides that the submarine vehicle comprises propulsion and maneuvering devices. By means of the propulsion and maneuvering devices, not only can the submarine vehicle be moved between two target positions, but a stable orientation of the submarine vehicle can be achieved with which the load can be received reliably in the storage area. For example, the submarine vehicle preferably comprises, as propulsion and maneuvering devices, a plurality of pivotable thrusters, ballast tanks and trim tanks and/or compensating tanks.

A further embodiment of the present invention provides that the submarine vehicle comprises a high-pressure pump for emptying, or pumping out, and filling, or flooding, a ballast tank, trim tank and/or compensating tank.

A further embodiment of the present invention provides that the submarine vehicle comprises a control unit for autonomous operation of the submarine vehicle during its dive, and/or that the submarine vehicle comprises an image acquisition unit for monitoring the surroundings. With the aid of the image acquisition unit, for example a camera or imaging sensor system, the submarine vehicle can be used to monitor tools or utensils arranged on the seabed. For example, pipelines which are provided for conveying hydrocarbons can be observed or checked.

A further embodiment of the present invention provides that, in the longitudinal direction of the submarine vehicle, the length of the storage area corresponds substantially to the length of the pressure hull. As a result, the storage area is extensively protected by the pressure hulls on the starboard side and/or port side, without it having to be surrounded entirely by a pressure hull. Furthermore, the propulsion and maneuvering devices can preferably be arranged on the pressure hull. As a result of the regular distribution of the propulsion and maneuvering devices along the longitudinal axis of the storage area, an irregular load distribution in the storage area can advantageously be compensated for. Otherwise, under certain circumstances, an irregular load distribution could result in the submarine vehicle tipping when the propulsion and maneuvering devices are limited to only one, comparatively small, area. In particular, as a result of the regular distribution of the propulsion and/or maneuvering device, an overall load that is as large as possible, for example consisting of the large number of loads stored in the storage area, can be conveyed. Furthermore, the submarine vehicle can move in as flexible and uncomplicated a manner as possible as a result of the regular distribution.

A further embodiment of the present invention provides that the submarine vehicle is configured for use from an offshore platform or a ship. Preferably, the ship and/or the offshore platform are also designed to receive the submarine vehicle. Preferably, ports are provided, via which fuel cell propellants (starting materials) are able to be filled into the corresponding fuel cell tanks of the submarine vehicle. Preferably, the submarine vehicle is filled and/or refueled in the moon pool of a ship or offshore platform, on the deck of a ship or offshore platform, or in an internal floating dock or a well deck of a ship or offshore platform. Preferably, filling or refueling takes place on calm seas. For further maintenance work, for example the cleaning of image acquisition units, divers are used or the submarine vehicle is lifted onto the deck of the offshore platform or ship by means of a powerful lifting device.

A further subject of the present invention is a method for picking a load up from the seabed using a submarine vehicle according to the invention as claimed in one of the preceding claims, wherein the load is picked up with the load transporting system.

In contrast to the prior art, the method can be repeated at different target positions during a dive on account of the suitably selected storage area. As a result, the method can advantageously be used to exchange loads extensively on the seabed.

A further embodiment provides that, prior to the pickup operation, i.e. temporally before the load arranged on the seabed is picked up, the submarine vehicle is maneuvered until the lower hatch is oriented above the load.

A further embodiment of the present invention provides that, prior to the pickup operation, a cable fastened to the load is grasped by a grasping device of the submarine vehicle, wherein the load is raised via the cable by means of the winch, wherein the pickup carriage is arranged beneath the raised load, wherein the load is set down on the pickup carriage by means of the winch and the pickup carriage with the set-down load is moved such that the load is arranged beneath the lower hatch. In particular, provision is made for the load to be picked up from the seabed during the dive, i.e. with a submarine vehicle in motion. As a result, time can advantageously be saved while the load is being picked up.

A further subject of the present invention is a method for setting a load down on the seabed using a submarine vehicle according to the invention, wherein the load is set down on the seabed with the load transporting system. As a result of the suitably selected storage area, a large number of loads can be set down on the seabed in an uncomplicated manner during a dive.

A further embodiment of the present invention provides that the load fastened to the pickup device is conveyed through the lower hatch and set down on the seabed.

Further details, features and advantages of the invention can be gathered from the drawings and from the following description of preferred embodiments with reference to the drawings. In this case, the drawings illustrate merely exemplary embodiments of the invention which do not limit the concept of the invention.

### BRIEF DESCRIPTION OF THE FIGURES

FIG. 1 shows a submarine vehicle in a first exemplary embodiment of the present invention in a sectional view taken perpendicularly to the longitudinal axis of the submarine vehicle.

FIG. 2 shows the submarine vehicle of the first exemplary embodiment of the present invention in a schematic plan view taken parallel to the longitudinal axis of the submarine vehicle.

FIG. 3 shows the submarine vehicle of the first exemplary embodiment of the present invention in a side view and a plan view.

FIG. 4 shows a pressure hull for a submarine vehicle according to a second exemplary embodiment of the present invention.

### EMBODIMENTS OF THE INVENTION

In the various figures, identical parts are always provided with the same reference signs and are therefore also each named or mentioned only once as a rule.

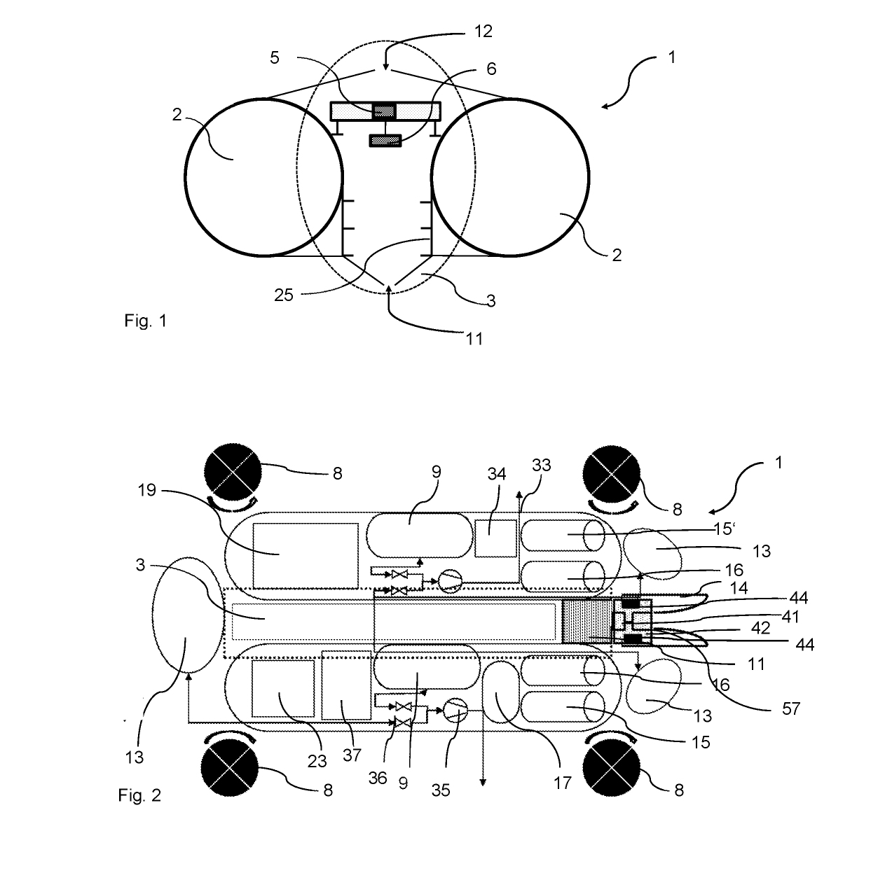

FIG. 1 illustrates a submarine vehicle 1 in a first exemplary embodiment of the present invention in a sectional view taken perpendicularly to the longitudinal axis of the submarine vehicle 1. Such a submarine vehicle 1 is preferably intended for picking up, storing, transporting and discharging loads 56, wherein the submarine vehicle 1 picks up, stores, transports and discharges loads 56. In particular, the submarine vehicle 1 is designed to pick up and set down loads 56 which are arranged or are intended to be arranged at a great depth on a seabed. In this case, the submarine vehicle 1 is configured such that it heads for several target positions, picks up and/or sets down loads 56 there and preferably stores or organizes the picked-up loads 56. In order to store the loads 56, the submarine vehicle 1 comprises a storage area 3 which preferably comprises sorting aids, for example shelves 25, and locking devices (not illustrated) in order to be able to safely store and transport the picked-up loads 56 in a manner protected against seawash or shocks. Preferably, the loads 56 are fuels which are provided for example for conveying hydrocarbons under water, for example hydraulic fluids and/or fluids for securing the oil flow in a conveyor pipe, or seismic sensors. In this case, provision is made for the submarine vehicle 1 to be configured such that it can travel to several target positions, for example several deposition locations for seismic sensors or different underwater production sites autonomously or by remote control. For example, provision is made for the submarine vehicle 1 to independently pick up an empty container as load 56 at one of the underwater production sites and to exchange it for a full container. In particular, provision is made for the submarine vehicle 1 to comprise a storage area 3 which is intended for the storage of a multiplicity of loads 56. In this case, provision is preferably made for the storage area 3 to be configured as a wet storage space, i.e. the storage area 3 is preferably permanently flooded with seawater. Preferably, the storage area 3 comprises, on its side facing the seabed, a lower hatch 11 and, on its side facing the sea surface (during a dive), an upper hatch 12, via which loads 56 and/or tools can preferably be introduced into or removed from the storage area 3. In order to pick up and/or to set down the load, a lifting device 5, preferably a crane, is provided, wherein the lifting device 5 picks up the load 56 by means of a pickup device 6, for example a suction bell or a grasper, and then conveys the load 56 into the storage area 3, out of the storage area 3 and/or within the storage area 3. Furthermore, provision is preferably made for further equipment, which is required for example to control the submarine vehicle 1, to be arranged in a pressure hull 2. In particular, the pressure hull 2 is spatially separated from the storage area 3. In other words, the storage area 3 is arranged outside the pressure hull 2. In the first embodiment illustrated in FIG. 1, the storage area 3 is arranged between two pressure hulls 2, wherein the pressure hulls 2 are each connected firmly, in particular rigidly, to the storage area 3. In this case, provision is made for a height of the storage area 3 to correspond substantially to a height of the pressure hulls 2 and for the two pressure hulls 2 and the storage area 3 to be arranged in a plane. As a result of this arrangement, the storage area 3 is surrounded by the pressure hulls 2, at least on the starboard and port side, and is thus at least partially protected thereby.

FIG. 2 illustrates the submarine vehicle 1 of the first exemplary embodiment of the present invention in a schematic plan view taken parallel to the longitudinal axis of the submarine vehicle 1. It can be seen that the storage area 3 extends along more than half of the total length of the submarine vehicle 1 in a longitudinal direction extending parallel to the longitudinal axis. Provision is furthermore made for the submarine vehicle 1 to comprise propulsion and maneuvering devices, for example thrusters 8, trim tanks and/or compensating tanks 9 and ballast tanks 13, with which the submarine vehicle 1 can be oriented or moved, i.e. maneuvered, during a dive. In particular, provision is made for the propulsion and maneuvering devices, for example the thrusters 8, to be arranged on the submarine vehicle 1, in particular on the outer casing thereof, in a circumferential direction extending parallel to the illustrated section plane. Preferably, the thrusters 8 are attached pivotably to the outer casing of the submarine vehicle 1, in order that the submarine vehicle 1 can be maneuvered as flexibly as possible during a dive. In order to carry out dives in which several target positions are intended to be traveled to, provision is made to supply the submarine vehicle with energy by means of a fuel cell system. Preferably, fuel tanks 15, 15′ are integrated into the pressure hulls 2 in order to realize the fuel cell system. In particular, hydrogen is integrated into the fuel tank 15 of one of the pressure hulls and oxygen is integrated into the fuel tank 15′ of the other of the pressure hulls. In order to generate the energy necessary for operation, reaction water tanks 16 are furthermore provided in the pressure hulls 2. Furthermore, the pressure hulls 2 preferably accommodate further equipment, for example a controller 23, a hydraulic pressure unit 34, a, preferably several, high-pressure trim and bilge pumps 35, an energy store 19, compensating tanks 9, a propulsion system 37 that is independent of outside air or a pressure accumulator 17, wherein the individual pressure hulls 2 are preferably equipped with different further equipment. Furthermore, provision is made for the submarine vehicle 1 to comprise a, preferably several, high-pressure pumps 35 with which the trim and compensating tanks and also the ballast tanks are emptied or flooded with respect to the external pressure. In order to regulate the filling levels in the individual trim and compensating tanks 9 and also the ballast tanks 13, the ballast, trim and compensating tanks are connected to the high-pressure pump 35 via valves 36. The water from the ballast, trim and compensating tanks is pumped to the outside via the high-pressure pump 35 with respect to the external pressure via the pressure line 33.

Provision is furthermore made for the submarine vehicle 1 to comprise a grasping device for picking up the loads 56. In particular, the grasping device comprises a winch 41 with one or more catching arms 57. FIG. 2 furthermore illustrates a guide 14. The guide 14 is formed by two curved protrusions on either side of the midship plane, the spacing apart of which decreases in the direction of the winch 41. On account of the tapering configuration of the guide 14, the submarine vehicle 1 can head for a cable 53, at the lower end of which the load 56 is arranged, at the target position. In particular, the guide 14 forms a guiding system for the cable 53, with the result that, in the event of a forward movement of the submarine vehicle 1, the cable 53 is conveyed in the direction of a winch 41 of the submarine vehicle 1. The winch 41 is preferably intended to receive the cable 53 and subsequently, by its operation, to raise the load 56 by winding up the cable 53. In particular, provision is made for the winch 41 to raise the load 56 until a pickup carriage 42 of the submarine vehicle 1 is able to be conveyed under the load 56. The pickup carriage 42, which is preferably movable in the longitudinal direction of the submarine vehicle 1, engages at least partially under the raised load 56. Subsequently, the load 56 can be set down on the pickup carriage 42 by the winch 41, in particular by actuation of the winch motor thereof. In particular, the cable 53 is then severed by means of a cutting device or a cutter 44 and subsequently the pickup carriage 42 is displaced until the load 56 is positioned beneath the lower hatch 11. The load 56 can be received in the storage area 3 of the submarine vehicle 1 through the open lower hatch 11 by means of the lifting device 5. In particular, a region of the lower hatch 11 immediately adjoins a region having the grasping device. In this case, it is conceivable for the lower hatch 11 to be dimensioned to receive an individual load and for the lifting device 5 to ensure that the load 56 is moved to the intended place in the storage area 3. Provision is furthermore made for the submarine vehicle 1 to pick up loads 56 by the submarine vehicle 1 being maneuvered until the load 56 to be picked up is arranged beneath the lower hatch 11. Subsequently, the load 56 arranged on the seabed can be conveyed into the storage region 3 directly via the lifting device 5.

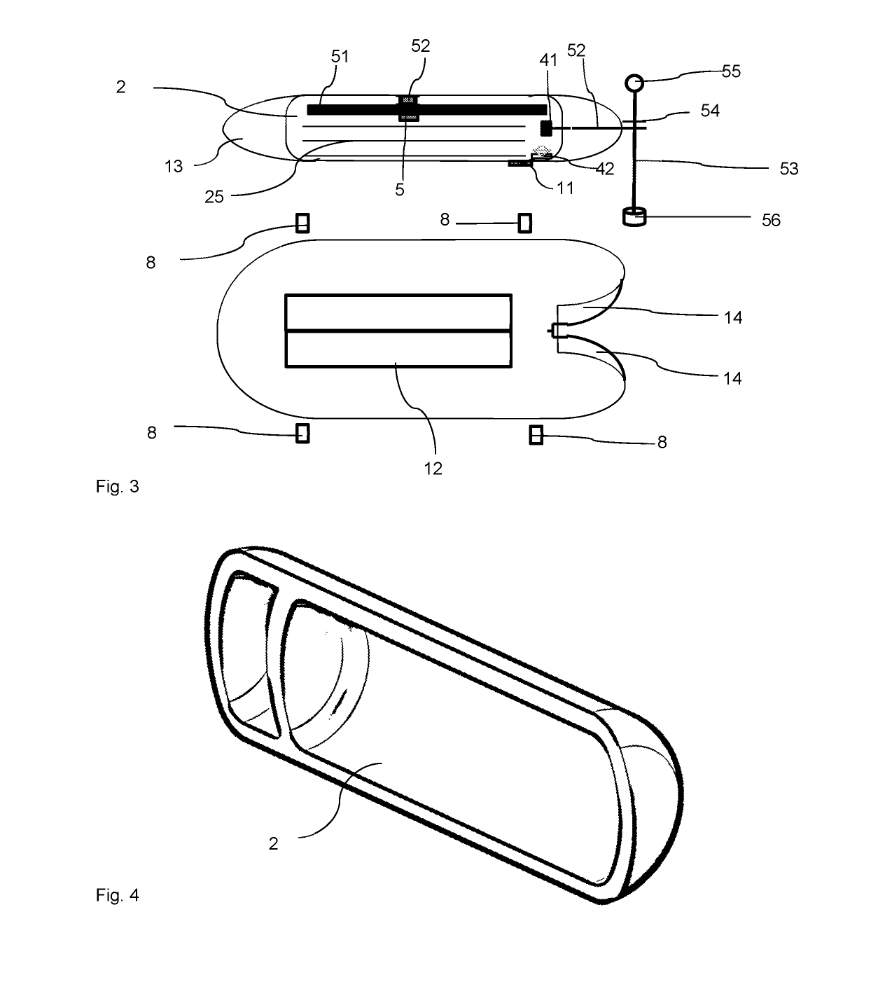

FIG. 3 illustrates the submarine vehicle 1 of the first exemplary embodiment of the present invention in a side view and a plan view. Preferably, the submarine vehicle 1 comprises, in the storage area 3, a rail system 51 along which the lifting device 5 is movable. In particular, the rail system 51 is configured or oriented such that the lifting device 5 is movable in a direction extending substantially parallel to the longitudinal direction of the submarine vehicle 1, for example via a trolley 52. As a result, a load 56 received in a front part of the submarine vehicle 1 can be conveyed for example into a rear part of the submarine vehicle 1 in order to store the load 56 there. As a result, the installation space of the lower hatch 11 can advantageously be restricted to the reception of an individual load 56 and at the same time the entire capacity of the storage area 3 can be used fully for a multiplicity of loads 56. With a small lower hatch, the storage area 3 can additionally be readily protected from external influences during the picking up or setting down of the load. Preferably, the cable 53, at the lower end of which the load 56 on the seabed is fastened, is connected at its upper end to a buoyant body 55. This buoyant body 55 ensures that the cable 53 extends—with as little movement as possible—from the seabed toward the sea surface. Preferably, the cable 53 furthermore comprises a delimiting means 54, wherein the region beneath the delimiting means 54 defines the region of the cable 51 that the grasping device may grasp. It is also conceivable for the delimiting means 54 to comprise a transmitter which serves to orient the submarine vehicle or co-controls navigation of the submarine vehicle 1. Furthermore, the submarine vehicle 1 comprises an upper hatch 12. Via the upper hatch 12, the loads are preferably conveyed out of the storage area 3 and into the storage area when the submarine vehicle 1 is at the water's surface. In particular, provision is made for the upper hatch 12 to be larger than the lower hatch 11, wherein the upper hatch 12 extends substantially along the entire extent of the storage region 3 located therebeneath.

FIG. 4 illustrates a pressure hull 2 for a submarine vehicle 1 according to a second exemplary embodiment of the present invention. For example, it is a pressure hull 2 which is used for the submarine vehicle 1 of the first exemplary embodiment. In this case, provision is made for the pressure hull 2 to exhibit a carbon fiber reinforced plastics material and titanium. In particular, the pressure hull 2 comprises titanium end plates. As a result of this particularly suitable choice of material and shaping of the pressure hull 2, the submarine vehicle 1 can advantageously be used up to several thousand meters beneath the sea surface during its dive.

### LIST OF REFERENCE SIGNS

1 Submarine vehicle
2 Pressure hull
3 Storage area
5 Lifting device
6 Pickup device
8 Thruster
9 Trim and compensating tank
11 Lower hatch
12 Upper hatch
13 Ballast tank
14 Guide
15,15′ Fuel tanks
16 Reaction water tank
17 Pressure accumulator
19 Energy store
23 Controller
25 Shelf
33 Pressure line
34 Hydraulic pressure unit HPU
35 High-pressure trim and bilge pumps
36 Valve
37 Propulsion system that is independent of outside air
41 Winch
42 Pickup carriage
44 Cutting device
51 Rail system
52 Trolley
53 Cable
54 Delimiting means
55 Buoyant body
56 Load
57 Catching arm

1-19. (canceled)

20. A submarine vehicle comprising:
a pressure hull; and
a storage area that is for storing loads and is disposed outside the pressure hull,
wherein the submarine vehicle is configured to at least one of pick a load up from a seabed or set a load down on the seabed.

21. The submarine vehicle of claim 20 wherein the submarine vehicle is at least one of operable autonomously or operable by remote control.

22. The submarine vehicle of claim 20 further comprising a fuel cell system for supplying the submarine vehicle with energy.

23. The submarine vehicle of claim 20 wherein the pressure hull comprises at least one of fiber-reinforced plastic or titanium.

24. The submarine vehicle of claim 20 wherein the storage area comprises at least one of
a lower hatch disposed on an underside of the pressure hull, or
an upper hatch disposed on a top side of the pressure hull.

25. The submarine vehicle of claim 20 further comprising a load transporting system for at least one of
picking the load up from the seabed,
setting the load down on the seabed, or
conveying the load within the storage area.

26. The submarine vehicle of claim 25 wherein the load transporting system comprises:
a lifting device for transporting the load in a substantially horizontal direction; and
a pickup device.

27. The submarine vehicle of claim 25 wherein the load transporting system comprises a rail system for transporting the load within the storage area.

28. The submarine vehicle of claim 20 further comprising:
a grasping device that comprises a catching arm for catching a cable fastened to the load;
a winch for raising the load;
a pickup carriage positionable beneath the raised load; and
a cutting device for cutting the cable fastened to the load.

29. The submarine vehicle of claim 20 wherein the pressure hull is a first pressure hull, the submarine vehicle further comprising a second pressure hull, wherein the storage area is disposed between the first pressure hull and the second pressure hull.

30. The submarine vehicle of claim 20 further comprising drive and maneuvering devices.

31. The submarine vehicle of claim 20 further comprising a pump for emptying and filling at least one of a ballast tank, a trim tank, or a compensating tank.

32. The submarine vehicle of claim 20 further comprising at least one of
a control unit for autonomous operation of the submarine vehicle during a dive, or
an image acquisition unit for monitoring surroundings.

33. The submarine vehicle of claim 20 wherein along a longitudinal axis of the submarine vehicle a length of the storage area corresponds substantially to a length of the pressure hull.

34. A method for picking a load up from a seabed using a submarine vehicle that includes a pressure hull, a storage area that is for storing loads and is disposed outside the pressure hull, and a load transporting system for picking the load up from the seabed, the method comprising picking up the load with the load transporting system.

35. The method of claim 34 wherein prior to picking up the load, the method further comprises maneuvering the submarine vehicle until a lower hatch of the storage area disposed on an underside of the pressure hull is positioned above the load on the seabed.

36. The method of claim 34 wherein picking up the load with the load transporting system comprises:
grasping a cable fastened to the load with a grasping device of the submarine vehicle;
raising the load via the cable by way of a winch;
positioning a pickup carriage beneath the raised load;
setting the load down on the pickup carriage by way of the winch; and
moving the pickup carriage and the load such that the load is positioned beneath a lower hatch of the storage area disposed on an underside of the pressure hull.

37. A method for setting a load down on a seabed using a submarine vehicle that includes a pressure hull, a storage area that is for storing loads and is disposed outside the pressure hull, and a load transporting system for setting down the load on the seabed, the method comprising setting down the load with the load transporting system.

38. The method of claim 37 wherein setting down the load with the load transporting system comprises:
conveying the load fastened to a pickup device through a lower hatch of the storage area disposed on an underside of the pressure hull; and
setting the load down on the seabed.
